(19) United States
(12) Patent Application Publication
(10) Pub. No.: US 2022/0083042 A1
(43) Pub. Date: Mar. 17, 2022

(54) INFORMATION PROCESSING DEVICE, INFORMATION PROCESSING METHOD, COMPUTER PROGRAM PRODUCT, AND INFORMATION PROCESSING SYSTEM

(71) Applicant: KABUSHIKI KAISHA TOSHIBA, Tokyo (JP)

(72) Inventors: Myungsook KO, Ota Tokyo (JP); Toshimitsu KUMAZAWA, Kawasaki Kanagawa (JP); Toru YANO, Shinagawa Tokyo (JP)

(73) Assignee: KABUSHIKI KAISHA TOSHIBA, Tokyo (JP)

(21) Appl. No.: 17/185,718

(22) Filed: Feb. 25, 2021

(30) Foreign Application Priority Data
Sep. 15, 2020 (JP) 2020-154355

(51) Int. Cl. G05B 23/02; G06K 9/00; G06F 9/38; G06F 9/50

(52) U.S. Cl. CPC G05B 23/0283; G06F 9/5011; G06F 9/3877; G06K 9/0063

(57) ABSTRACT

An information processing device includes a sufficiency determiner, a diagnostic unit, a request data generator, and a deliverer. The sufficiency determiner determines, concerning each diagnostic item in a target, whether plural pieces of inspection result data indicating inspection result by users, differing from a professional include sufficient pieces of effective inspection result data for diagnosing. The diagnostic unit diagnoses, concerning the diagnostic item, the condition of the target based on the plural inspection result data pieces when the plural inspection result data include sufficient pieces of inspection result data for diagnosing. The request data generator generates, concerning the diagnostic item, request data for requesting the users to conduct an inspection when the plural inspection result data pieces do not include sufficient pieces of inspection result data for diagnosing. The deliverer deliver the request data to user terminals.

### CROSS-REFERENCE TO RELATED APPLICATIONS

This application is based upon and claims the benefit of priority from Japanese Patent Application No. 2020-154355, filed on Sep. 15, 2020; the entire contents of which are incorporated herein by reference.

### FIELD

Embodiments described herein relate generally to an information processing device, an information processing method, a computer program product, and an information processing system.

### BACKGROUND

For countermeasures against age deterioration, failure, and so on of social infrastructures, structures such as buildings, and various-kind equipment, the condition thereof need to be periodically inspected and diagnosed on the basis of the result of the inspection. The inspection of a target for diagnosis is conducted by, for example, visual inspection of the appearance of the target, image-capturing of an appearance image with an imaging device, audio recording, and measurement with various measuring instruments. Such inspections are generally carried out by a professional.

Further, in order to address the shortage of professionals due to declining birthrate and increasing aging population, and the like, remote monitoring systems are being introduced. However, concerning diagnostic items for which an inspection can be easily conducted if a human worker goes to the site, the introduction of such a remote monitoring system increases the installation and maintenance costs of an imaging device, a measuring device, and so on. In view of this, concerning the diagnostic items for which an inspection can be easily conducted once if a human worker goes to the site, a professional has to visit the site instead of the introduction of such a remote monitoring system.

### BRIEF DESCRIPTION OF THE DRAWINGS

FIG. 1 is a diagram illustrating a diagnostic system;

FIG. 2 is a diagram illustrating the configuration of a diagnostic device according to a first embodiment;

FIG. 3 is a diagram illustrating an example of request data;

FIG. 4 is a diagram illustrating an example of inspection result data for a case where a meter value is recorded;

FIG. 5 is a diagram illustrating an example of inspection result data for a case where an appearance image of equipment is recorded;

FIG. 6 is a diagram illustrating an example of diagnostic result data;

FIG. 7 is a diagram illustrating an example of delivery data;

FIG. 8 is a flowchart depicting the flow of processing of a diagnostic system;

FIG. 9 is a flowchart depicting sufficiency determination processing;

FIG. 10 is a flowchart of diagnostic processing for a case where a numerical value is recorded;

FIG. 11 is a flowchart of diagnostic processing for a case where image data is recorded;

FIG. 12 is an explanatory diagram of processing for assigning an importance degree;

FIG. 13 is a diagram illustrating the configuration of a diagnostic device according to a second embodiment;

FIG. 14 is a diagram illustrating the configuration of a diagnostic device according to a third embodiment;

FIG. 15 is a diagram illustrating the configuration of a diagnostic device according to a fourth embodiment; and

FIG. 16 is a diagram illustrating the hardware configuration of a diagnostic device.

### DETAILED DESCRIPTION

According to an embodiment, an information processing device diagnosing a condition of a target, the device includes one or more hardware processors configured to function as a sufficiency determiner and a diagnostic unit. The sufficiency determiner is configured to determine, concerning a diagnostic item to be diagnosed for the target, whether or not a plurality of pieces of inspection result data include sufficient number of pieces of inspection result data for diagnosing, where each of the plurality of pieces of inspection result data is indicative of a result of an inspection conducted by a user who inspects the condition of the target. The diagnostic unit is configured to diagnose, concerning the diagnostic item, the condition of the target on a basis of the plurality of pieces of inspection result data in a case where the plurality of pieces of inspection result data include sufficient number of pieces of inspection result data for diagnosing. Embodiments herein provide an information processing device, an information processing method, a computer program product, and an information processing system that reduce the workload on a professional (an inspector).

Hereinafter, a diagnostic system 10 according to an embodiment is described with reference to the drawings.

### First Embodiment

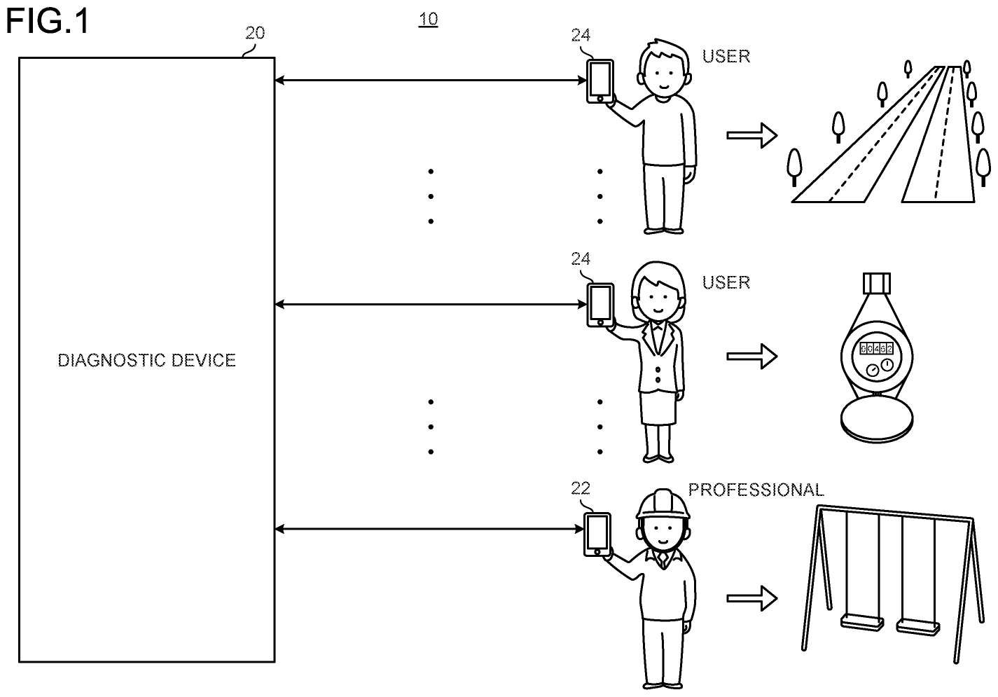

FIG. 1 is a diagram illustrating the diagnostic system 10.

In the diagnostic system 10 (information processing system), a plurality of users, who are different from a professional who inspects the condition of a target, is sent to a location where the target is installed. The diagnostic system 10 makes the plurality of users conduct an inspection to diagnose the condition of the target.

Examples of the target include social infrastructures such as roads, bridges, and plumbing. The target may also be a building or a public facility such as playground equipment.

The inspection is carried out in order to diagnose the condition of the target. The inspection is carried out by, for example, visual inspection of the appearance of the target, image-capturing of an appearance image with an imaging device, audio recording, and check of a value of a measuring instrument attached to the target or provided in the vicinity of the target. Note that the inspection is not limited to the inspection mentioned above, and the user may carry out another inspection. The diagnostic system 10 then diagnoses the condition of the target on the basis of a plurality of pieces of inspection result data acquired as a result of the inspections by the plurality of users.

For example, the diagnostic system 10 diagnoses to output a diagnostic result indicating that the target is in a satisfactory condition, that the target is in a condition where maintenance is required, that the target is in a condition where immediate maintenance is not necessary but continuous observation is required, and so on. Note that the diagnostic result is not limited to the diagnostic result mentioned above, and the diagnostic system 10 may output another diagnostic result. For example, the diagnostic system 10 may output, as the diagnostic result, a degree of age deterioration of the target.

The diagnostic system 10 may also make a professional inspect the target instead of making the plurality of users inspect the target. In such a case, the professional further diagnoses the condition of the target on the basis of the inspection result acquired as a result of the inspection by the professional himself/herself.

The diagnostic system 10 includes a diagnostic device 20 (information processing device), a professional terminal 22, and a plurality of user terminals 24.

The diagnostic device 20 is an information processing device for performing information processing. The diagnostic device 20 can perform communication with another device via a network. The diagnostic device 20 may be a computer housed in one casing, or a cloud in which a plurality of computers provided over a network works together.

The professional terminal 22 is held by the professional. The professional terminal 22 is a computer that can perform communication with the diagnostic device 20. The professional terminal 22 is a device having a data display function, a data input function, and a wireless data communication function. The professional terminal 22 is a portable device such as a smartphone, a tablet PC, and a mobile phone, for example.

Each of the plurality of user terminals 24 is held by a user. Each of the plurality of user terminals 24 is a computer that can perform communication with the diagnostic device 20. Each of the plurality of user terminals 24 is a device having a data display function, a data input function, and a wireless data communication function. Each of the plurality of user terminals 24 is a portable device such as a smartphone, a tablet PC, and a mobile phone, for example.

The diagnostic device 20 delivers, concerning a diagnostic item to be diagnosed for a target to be diagnosed, delivery data including request data for requesting an inspection to the plurality of user terminals 24. Each of the plurality of users checks the delivery data with the user terminal 24 held by himself/herself, goes to the location of the target indicated in the delivery data, and inspects the target for the diagnostic items indicated in the delivery data. Each of the plurality of users then sends inspection result data indicating the inspection result to the diagnostic device 20 with the user terminal 24 held by himself/herself. The diagnostic device 20 diagnoses the condition of the target on the basis of the plurality of pieces of inspection result data received from the plurality of users.

Alternatively, concerning the diagnostic item in the target, the diagnostic device 20 sometimes instructs a professional to conduct an inspection and a diagnosis instead of requesting the plurality of users to conduct an inspection. The professional goes to the location of the target in accordance with the instructions and inspects the target for the diagnostic item. The professional further diagnoses the condition of the target on the basis of the inspection conducted by himself/herself. The professional sends inspection result data indicating the inspection result and diagnostic result data indicating the diagnostic result to the diagnostic device 20 with the professional terminal 22 held by himself/herself. The diagnostic device 20 stores the inspection result data and the diagnostic result data sent from the professional terminal 22.

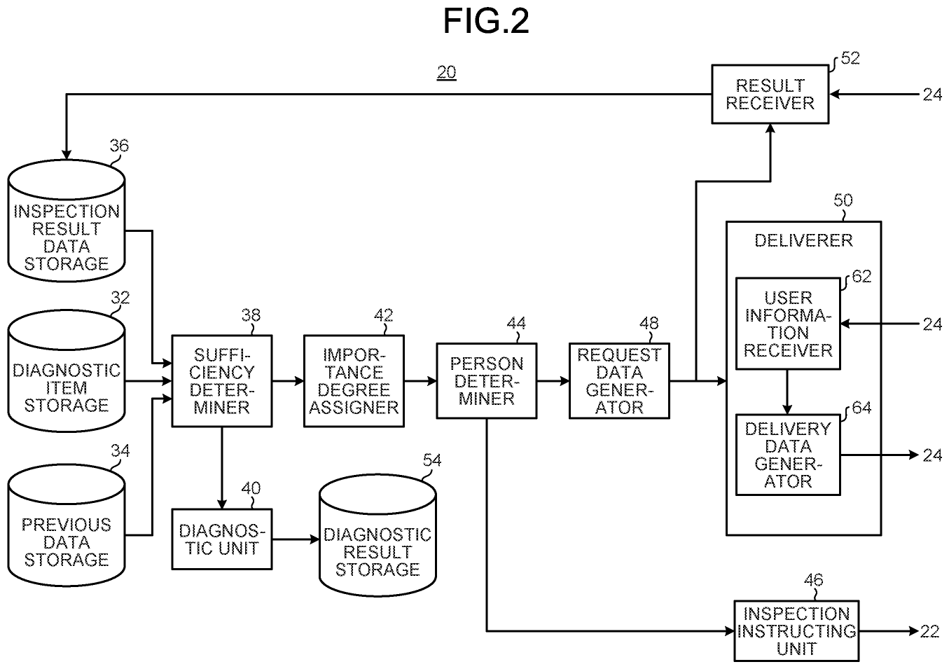

FIG. 2 is a diagram illustrating the functional configuration of the diagnostic device 20 according to the first embodiment. The diagnostic device 20 according to the first embodiment includes diagnostic item storage 32, previous data storage 34, inspection result data storage 36, a sufficiency determiner 38, a diagnostic unit 40, an importance degree assigner 42, a person determiner 44, an inspection instructing unit 46, a request data generator 48, a deliverer 50, a result receiver 52, and diagnostic result storage 54.

The diagnostic item storage 32 stores a diagnostic item to be diagnosed for a target to be diagnosed. The diagnostic item is registered in advance by an administrator and so on. The diagnostic item storage 32 may store a plurality of diagnostic items.

The diagnostic item includes the details of diagnosis and the details of inspection necessary to diagnose. For example, the details of diagnosis indicate “satisfactory” if a meter value of the measuring instrument for measuring usage of the target is equal to or smaller than a set reference value, and the details of diagnosis indicate that maintenance is required if the meter value of the measuring instrument is greater than the reference value, for example. In such a case, the details of inspection indicate that a meter value of the measuring instrument is to be recorded, for example.

The details of diagnosis may indicate, for example, that a check is to be made whether or not rust on the external configuration of the target is within a given rate of the total. In such a case, the details of inspection indicate that an image of the external configuration of the target is to be recorded, for example.

The details of diagnosis indicate that a check is to be made whether or not the number of cracks of the target is equal to or smaller than a set reference value, for example. In such a case, the details of inspection indicate that the number of cracks of the target visually checked is to be recorded, for example.

The previous data storage 34 stores a plurality of pieces of professional inspection result data for each of the plurality of diagnostic items. Each set of the plurality of pieces of professional inspection result data indicates a result of the previous inspections conducted for the target diagnostic item by the professional.

The inspection result data storage 36 stores a plurality of pieces of inspection result data for each of the plurality of diagnostic items. Each of the plurality of inspection results indicates a result of the inspection conducted for the target diagnostic item by the user after the latest date and time of diagnosis.

The sufficiency determiner 38 determines, for each diagnostic item, whether or not the plurality of pieces of inspection result data include sufficient number of pieces of inspection result data for diagnosing. In this embodiment, the sufficiency determiner 38 determines, for each diagnostic item, whether or not the plurality of pieces of inspection result data include sufficient number of pieces of effective inspection result data for diagnosing. The effective inspection result data is sufficiently quality data for diagnosing. For example, the sufficiency determiner 38 determines, concerning a diagnostic item, whether or not the plurality of pieces of inspection result data include sufficient number of pieces of effective inspection result data for diagnosing after a given time elapses since the last diagnosing date and time. For example, the sufficiency determiner 38 determines, for each diagnostic item, that the plurality of pieces of inspection result data include sufficient number of pieces of effective inspection result data for diagnosing if the number of pieces of inspection result data is equal to or greater than a preset threshold, and if at least a given rate (90%, for example) of the plurality of pieces of inspection result data is included within a rage defined on the basis of a lower limit value and an upper limit value of the plurality of pieces of professional inspection result data which indicate the results of the inspections previously conducted by the professional. The sufficiency determiner 38 repeats such determination processing until the plurality of pieces of inspection result data include sufficient number of pieces of effective inspection result data for diagnosing.

The diagnostic unit 40 diagnoses, concerning the diagnostic item, the condition of the target on the basis of the plurality of pieces of inspection result data if the plurality of pieces of inspection result data stored in the inspection result data storage 36 include sufficient number of pieces of effective inspection result data for diagnosing.

If the plurality of pieces of inspection result data do not include sufficient number of pieces of effective inspection result data for diagnosing, then the importance degree assigner 42 assigns an importance degree of diagnosis to the diagnostic item. As more speedy or accurate diagnosing for the target diagnostic item is required, the importance degree assigner 42 assigns the heightened importance degree.

For example, the importance degree assigner 42 heightens the importance degree as the elapsed time increases since the latest diagnosing date and time for a diagnostic item. Another configuration is usable in which an influence (a degree of influence) is preset in the diagnostic item, and the greater the influence set for the diagnostic item is, the importance degree assigner 42 heightens the importance degree. Yet another configuration is usable in which the importance degree assigner 42 heightens importance degree as a rate of the number of pieces of effective inspection result data included in the plurality of pieces of inspection result data relative to the preset number for the diagnostic item lowers. Yet another configuration is usable in which the importance degree assigner 42 heightens the importance degree as the elapsed time since the latest (last) diagnosing date and time increases.

The person determiner 44 determines, for each diagnostic item, whether or not the importance degree is higher than a preset value. If, concerning the target diagnostic item, the importance degree is higher than the preset value, then the person determiner 44 determines that instructions to conduct an inspection are given to a professional who inspects the condition of the target. If the importance degree is equal to or lower than the preset value, then the person determiner 44 determines that a request to conduct an inspection is made to a plurality of users.

The inspection instructing unit 46 instructs the professional to conduct an inspection for the diagnostic item if the plurality of pieces of inspection result data do not include sufficient number of pieces of effective inspection result data for diagnosing and if the importance degree is higher than the preset value.

The request data generator 48 generates request data for requesting the user or users to conduct an inspection for the diagnostic item if the plurality of pieces of inspection result data do not include sufficient number of pieces of effective inspection result data for diagnosing and if the importance degree is equal to or lower than the preset value.

The deliverer 50 delivers, for each diagnostic item, delivery data including request data and related information necessary for inspection to the plurality of user terminals 24 held by the users via a network. The deliverer 50 includes, for example, a user information receiver 62 and a delivery data generator 64. The user information receiver 62 receives, from the user terminal 24 held by each of the plurality of users, user information on a position of the corresponding user, and so on. The delivery data generator 64 selects, for each of the plurality of users, a diagnostic item for which inspection can be conducted on the basis of the user information, and delivers the delivery data including the request data for the selected diagnostic item to the corresponding user terminal 24. Further, the delivery data generator 64 delivers, for one diagnostic item, delivery data including the same request data to the plurality of users. Further, the delivery data generator 64 may deliver, to one user, delivery data including various types of request data.

The result receiver 52 receives, for each diagnostic item, inspection result data from the user terminal 24 of each of the plurality of users to add the inspection result data to a plurality of pieces of inspection result data on the corresponding diagnostic item stored in the inspection result data storage 36. This enables the result receiver 52 to increase the number of plurality of pieces of inspection result data stored in the inspection result data storage 36.

The result receiver 52 further provides an incentive according to the importance degree assigned for the corresponding diagnostic item to the user who has sent the inspection result data. For example, the higher importance degree the target diagnostic item receives, the higher incentive the result receiver 52 provides.

The diagnostic result storage 54 stores, for each diagnostic item, diagnostic result data indicating the diagnostic result by the diagnostic unit 40.

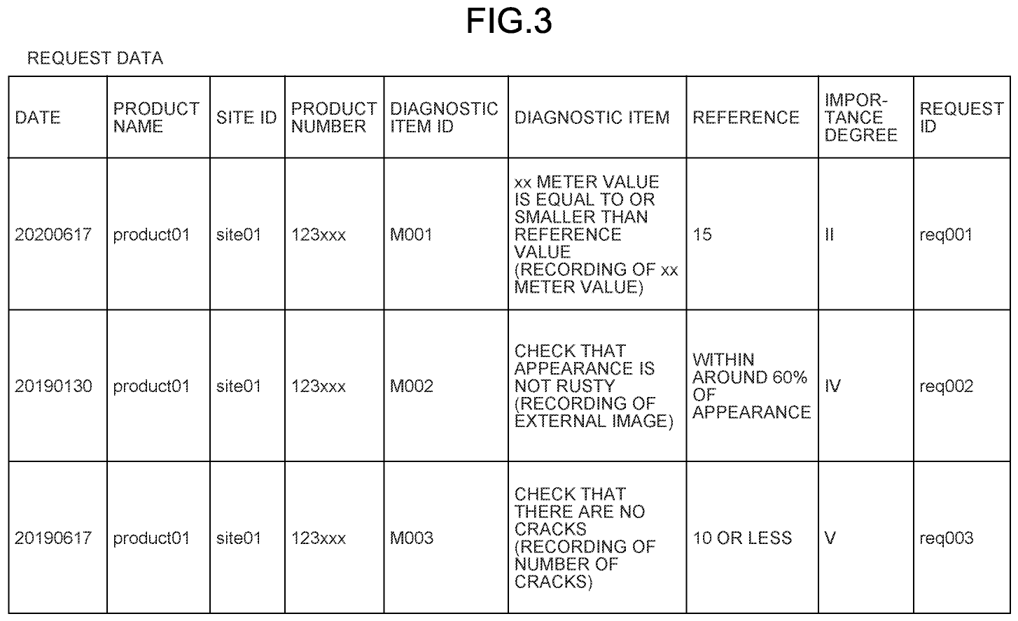

FIG. 3 is a diagram illustrating an example of the request data. The request data includes information for identifying a target, information for identifying the details of inspection and the details of diagnosis, an importance degree, and information for identifying the request.

The request data exemplified in FIG. 3 includes a date, a product name, a site ID, a product number, a diagnostic item ID, a diagnostic item, a reference, an importance degree, and a request ID. The date represents a date at which the request data is generated. The product name, the site ID, and the product number are information for identifying a target.

The diagnostic item ID, the diagnostic item, and the reference are information for identifying the details of inspection and the details of diagnosis. The importance degree represents a level of an importance degree. The request ID is information for identifying the request data.

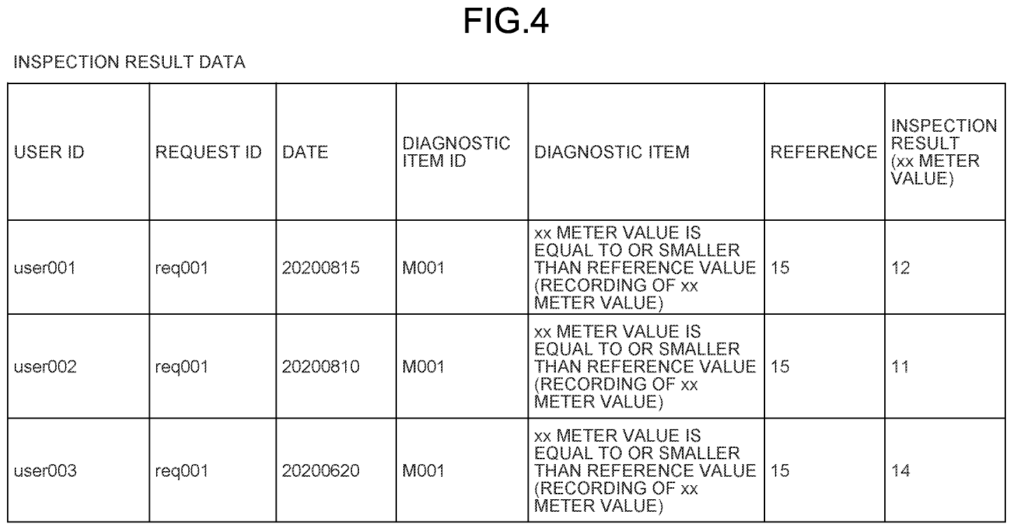

FIG. 4 illustrates an example of inspection result data for a case where a meter value is recorded. The inspection result data includes information for identifying a user who has conducted the inspection, information for identifying the corresponding request data, and the inspection result.

The inspection result data exemplified in FIG. 4 includes a user ID, a request ID, a date, a diagnostic item ID, a diagnostic item, a reference, and inspection result data. The user ID is information for identifying a user who has conducted the inspection. The request ID is information for identifying the corresponding request data. The date is information representing a date at which the inspection is conducted. The diagnostic item ID, the diagnostic item, and the reference are information for identifying the details of diagnosis and the details of inspection.

The inspection result is data acquired as a result of an inspection conducted by the user. In the example of FIG. 4, the inspection result is a meter value of a measuring instrument that is mounted on the target or provided in the vicinity of the target. For example, the user makes a visual check to read a numerical value of the meter of the measuring instrument, and sends the numerical value thus read as an inspection result from the user terminal 24 to the diagnostic device 20.

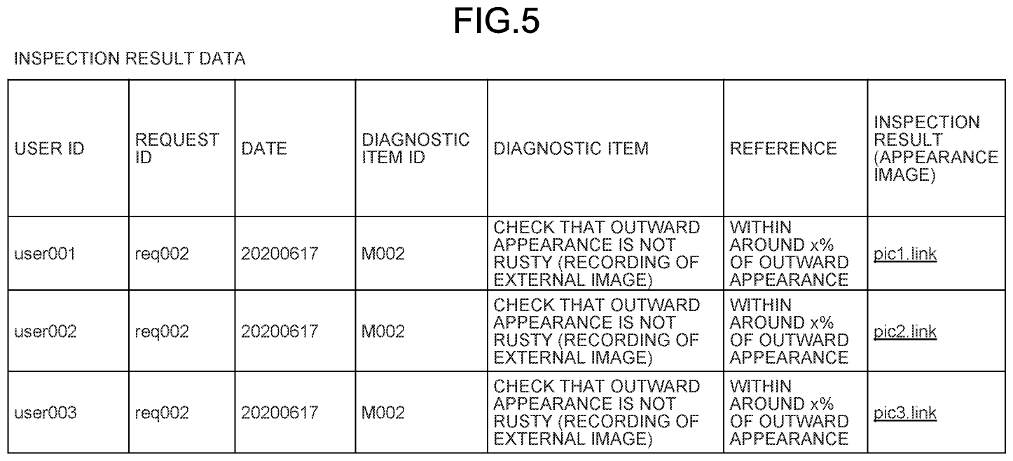

FIG. 5 is a diagram illustrating an example of inspection result data for a case where an appearance of equipment is recorded. The inspection result data exemplified in FIG. 5 differs from that of FIG. 4 in data included in the inspection result. In the example of FIG. 5, the inspection result is image data acquired by image-capturing of the appearance of the target. In the example of FIG. 5, the image data is stored at an address illustrated in a link. The user uses, for example, the user terminal 24 to capture the appearance of the target to send, as the inspection result, the captured image from the user terminal 24 to the diagnostic device 20.

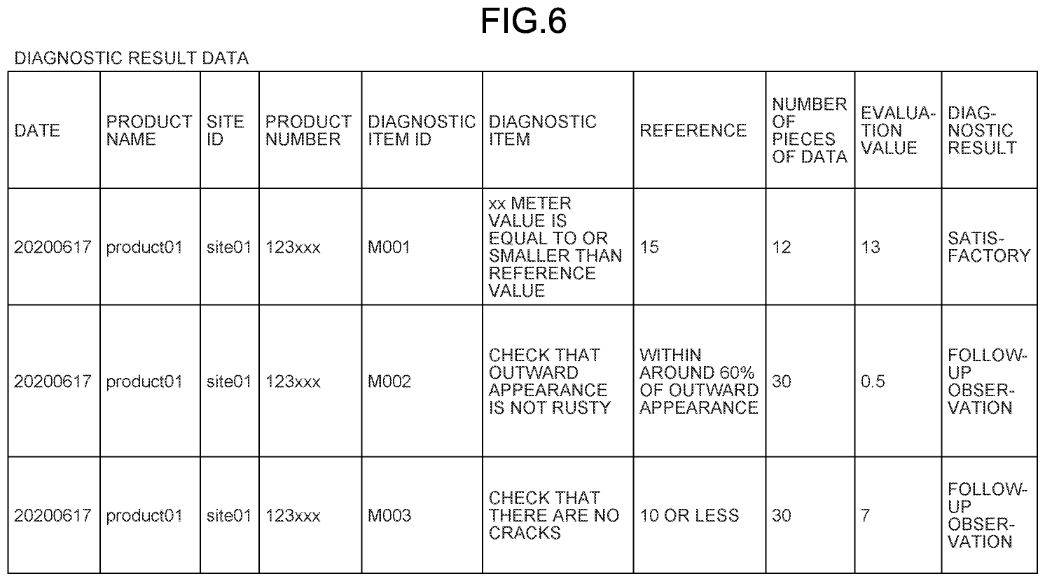

FIG. 6 is a diagram illustrating an example of diagnostic result data. The diagnostic result data includes information for identifying a target, information for identifying the details of inspection and the details of diagnosis, and information indicating the diagnostic result of the condition of the target.

The diagnostic result data exemplified in FIG. 6 includes a date, a product name, a site ID, a product number, a diagnostic item ID, a diagnostic item, a reference, the number of pieces of data, an evaluation value, and a diagnostic result. The date represents a date at which the diagnosis is conducted. The product name, the site ID, and the product number are information for identifying a target. The diagnostic item ID, the diagnostic item, and the reference are information for identifying the details of diagnosis and the details of inspection.

The number of pieces of data, the evaluation value, and the diagnostic result are information indicating the diagnostic result of the condition of the target. The number of pieces of data indicates the number of pieces of inspection result data used for the diagnosis.

The evaluation value is a value generated from the plurality of pieces of inspection result data used for the diagnosis. The evaluation value is, for example, an average, a mode, or the like of the plurality of pieces of inspection result data. Further, in a case where the inspection result data is image data or audio data, the evaluation value is an average, a mode, or the like of an analysis value acquired by analyzing the image data or the audio data.

The diagnostic result is a result acquired after the comparison of the evaluation value with the reference value. The diagnostic result is information, for example, indicating that the target is in a satisfactory condition, that the target is in a condition where maintenance is required, or that the target is in a condition where continuous observation of the target (follow-up) is required.

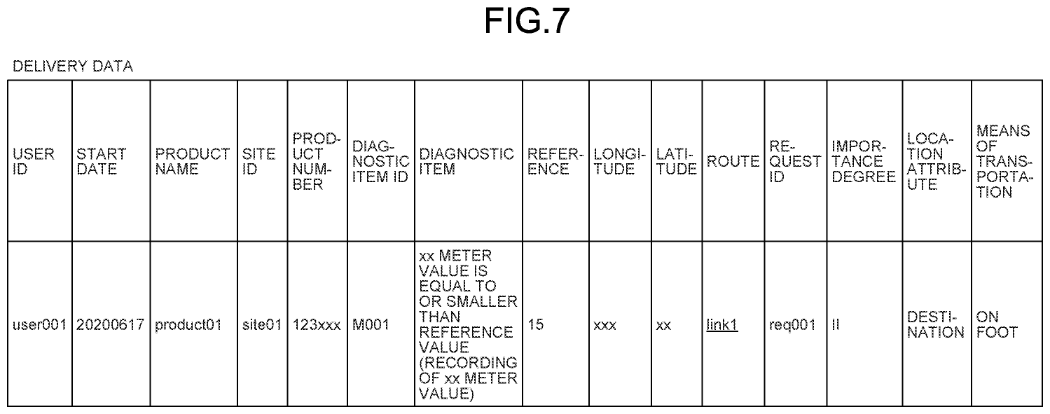

FIG. 7 is a diagram illustrating an example of the delivery data. The delivery data includes request data and given types of information.

The delivery data includes, for example, a user ID, a start date, a product name, a site ID, a product number, a diagnostic item ID, a diagnostic item, a reference, latitude, longitude, a route, a request ID, an importance degree, a location attribute, a means of transportation, and route information.

The user ID is information for identifying a user to whom the delivery data is to be sent. The start date is a date at which the delivery data is sent.

The product name, the site ID, and the product number are information for identifying the target. The product name, the site ID, and the product number are information included in the request data.

The diagnostic item ID, the diagnostic item, and the reference are information for identifying the details of inspection and the details of diagnosis. The diagnostic item ID, the diagnostic item, and the reference are information included in the request data.

The latitude and the longitude are information indicating the location of the target. The diagnostic device 20 acquires the latitude and the longitude on the basis of the information for identifying the target.

The route is information indicating a route from a starting position of the user to the target. The route can be obtained, for example, by having a map service server search for the route.

The request ID is information for identifying the request data. The importance degree represents a level of an importance degree. The request ID and the importance degree are information included in the request data.

The location attribute is information indicating, for example, a location of the target between a starting point and a destination in a case where the user moves from the starting point to the destination. The means of transportation is information indicating a means of transportation used by the user. The diagnostic device 20 delivers such delivery data to the user terminal 24 via the network.

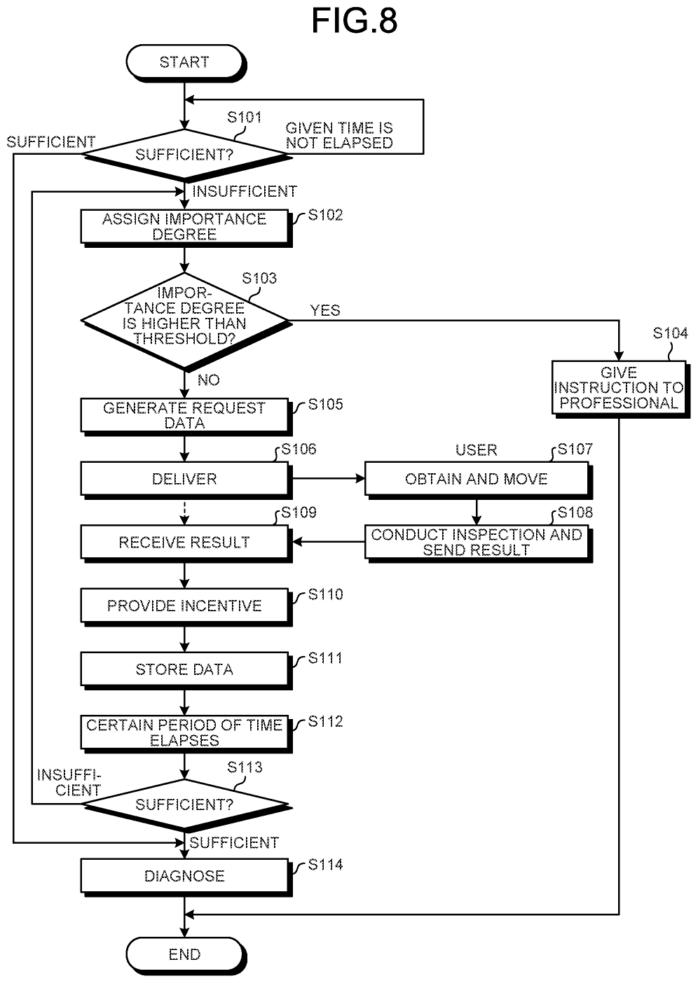

FIG. 8 is a flowchart depicting the flow of processing of the diagnostic system 10. The diagnostic system 10 performs processing, for each of the plurality of diagnostic items, in the flow depicted in FIG. 8.

First, in S101, the diagnostic device 20 performs sufficiency determination processing for a target diagnostic item. More specifically, concerning the target diagnostic item, the diagnostic device 20 determines whether or not the plurality of pieces of inspection result data stored in the inspection result data storage 36 include sufficient number of pieces of effective inspection result data for diagnosing, or determines whether or not a given time has elapsed since the latest diagnosing date and time. The inspection result data storage 36 stores, concerning the target diagnostic item, the diagnostic result data acquired as a result of the inspection conducted by the user after the latest diagnosing date and time.

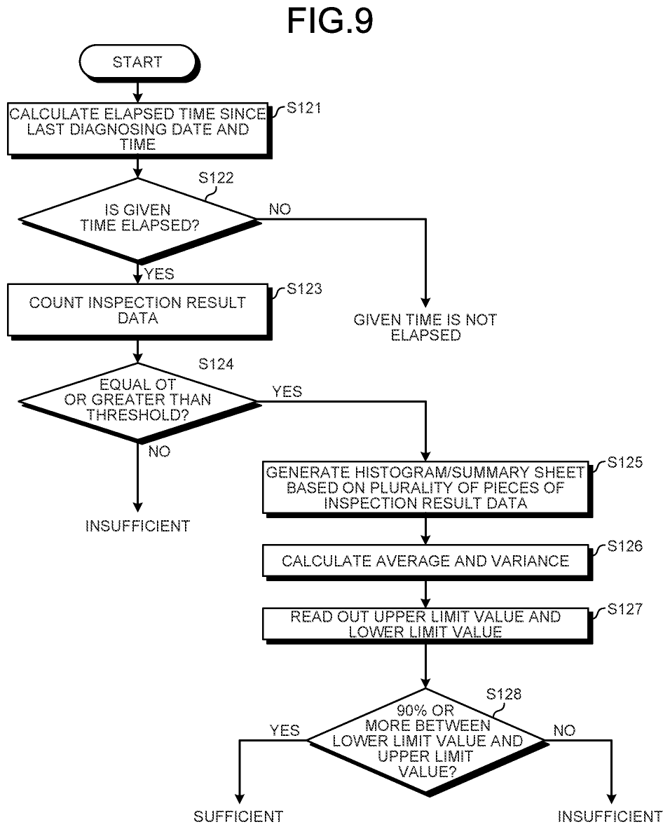

If the given time has not yet elapsed since the latest diagnosing date and time (given time not yet elapsed in S101), then the diagnostic device 20 waits at S101. If the given time has elapsed since the latest diagnosing date and time, and further, if the plurality of pieces of inspection result data include sufficient number of pieces of effective inspection result data for diagnosing (sufficient in S101), then the diagnostic device 20 proceeds to S114. If the given time has elapsed since the latest diagnosing date and time, and further, if the plurality of pieces of inspection result data do not include sufficient number of pieces of effective inspection result data for diagnosing (insufficient in S101), then the diagnostic device 20 proceeds to S102. Note that an example of the specific sufficiency determination processing of S101 is further described with reference to FIG. 9.

In S102, the diagnostic device 20 assigns an importance degree of diagnosis concerning the target diagnostic item. As more speedy or accurate diagnosing for the target diagnostic item is required, the diagnostic device 20 assigns the heightened importance degree.

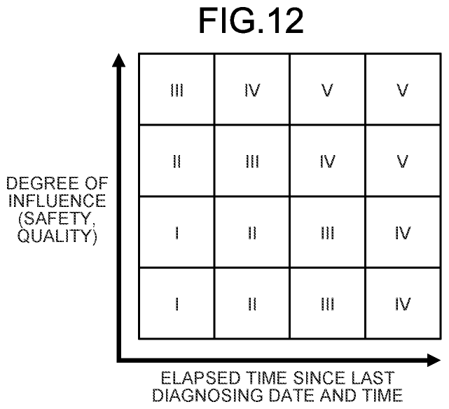

For example, the diagnostic device 20 assigns the heightened importance degree as the elapsed time increases since the latest (last) diagnosing date and time for a target diagnostic item. Further, for example, an influence (a degree of influence) may be preset for each of the plurality of diagnostic items stored in the diagnostic item storage 32. In such a case, the greater the influence set for the target diagnostic item is, the higher importance degree the diagnostic device 20 assigns. Further, for example, the diagnostic device 20 may heighten the importance degree as the rate of the number of pieces of effective inspection result data included in the plurality of pieces of inspection result data relative to the preset number of the target diagnostic item lowers. Further, the diagnostic device 20 may determine the importance degree by combining the elapsed time since the latest diagnosing date and time, the preset influence, and the rate of the number of pieces of effective inspection result data relative to the preset number. Note that an example of the processing for assigning the importance degree in S102 is further described with reference to FIG. 12.

Subsequently, in S103, the diagnostic device 20 determines whether or not the importance degree assigned to the target diagnostic item is higher than a preset value (threshold). If the importance degree is higher than the preset value (Yes in S103), then the diagnostic device 20 proceeds to S103. If the importance degree is equal to or lower than the preset value (No in S103), then the diagnostic device 20 proceeds to S105.

In S104, the diagnostic device 20 instructs a professional who inspects the condition of the target to carry out an inspection for the target diagnostic item. For example, the diagnostic device 20 sends instruction data for instructing the inspection for the target diagnostic item to the professional terminal 22 held by the professional via the network. Alternatively, the diagnostic device 20 may send the instruction data to a server of an inspection company that employs the professional. In such a case, the inspection company instructs any professional to conduct an inspection.

The professional instructed to conduct an inspection moves to a location where the target is installed, for example, on foot, by train, or car, and conducts an inspection indicated in the instruction data. The professional further diagnoses the condition of the target for the target diagnostic item on the basis of the inspection result data acquired as a result of the inspection. The professional then uses the professional terminal 22 to send the inspection result data and the diagnostic result data indicating the diagnostic result to the diagnostic device 20. The diagnostic device 20 receives the inspection result data and the diagnostic result data to store the same into the previous data storage 34, for example. When the processing in S104 is finished, the diagnostic device 20 ends the flow of processing.

In S105, the diagnostic device 20 generates request data for requesting the user or users to conduct an inspection for the target diagnostic item. The request data includes information for identifying the target, information for identifying the details of inspection, the importance degree, and the information for identifying the request. The information for identifying the target includes information indicating the location of the target.

In S106, the diagnostic device 20 delivers delivery data including the generated request data to the plurality of user terminals 24 held by the users via the network. The diagnostic device 20 generates the delivery data including the request data and given types of information to deliver the delivery data to the plurality of user terminals 24 held by the users in a given manner. For example, the diagnostic device 20 generates delivery data including the location of the target (latitude and longitude) and route information indicating a route to the target.

The diagnostic device 20 may, for example, push the delivery data to each of the plurality of user terminals 24. The diagnostic device 20 may upload the delivery data to a server or the like, which allows the user to access the server with the user terminal 24 to download the delivery data.

Further, the diagnostic device 20 acquires, from the user terminals 24 held by the plurality of users, user information including the current location of the user and a means of transportation used by the user. The diagnostic device 20 then selects one or more users who can conduct an inspection from among the plurality of users on the basis of the location of the target (latitude and longitude), the current location of the user, and the means of transportation. For example, the diagnostic device 20 selects one or more users who can move to the location of the target within a given time from the current time. The diagnostic device 20 then may deliver the delivery data to the one or more users thus selected.

Further, the diagnostic device 20 may acquire user information including the starting point, the destination, and the movement route from a user who is moving or is to move. In such a case, the diagnostic device 20 selects, from among the plurality of diagnostic items, a diagnostic item corresponding to a target which is located on the route between the starting point and the destination, or located within a given distance from the route. The diagnostic device 20 then may deliver delivery data for the selected diagnostic item to the user who is moving or is to move.

Further, the diagnostic device 20 may send, to a single user, delivery data including a plurality of pieces of request data for the plurality of diagnostic items.

Further, the diagnostic device 20 may incorporate, into the delivery data, the route information indicating the movement route from the current location of the user to the target. The diagnostic device 20 may change the route information according to the means of transportation used by the user included in the user information. Further, in a case where the delivery data including a plurality of pieces of request data is sent to one user, the diagnostic device 20 may incorporate, into the delivery data, route information indicating a movement route through a plurality of targets in turn.

Further, the diagnostic device 20 may incorporate, into the delivery data, information to assist in the entry of an inspection conducted by the user and the inspection result data. For example, the diagnostic device 20 may incorporate, into the delivery data, choices of values to be inputted as the inspection result data or choices of conditions to be entered by the user. Further, the diagnostic device 20 may incorporate description of how to conduct an inspection, and so on.

Further, the diagnostic device 20 may incorporate the generated delivery data into content data that is referred to using an application program. The application program is executed in the user terminal 24. For example, the diagnostic device 20 may link map data with positional data of the user terminal 24 to incorporate the delivery data into content data for providing service to the user.

The content data may be, for example, game data that causes a given event to occur in the application program when the user performs given operation with the user terminal 24 at a specific location illustrated in the map data. In this case, for example, the content data may be data that causes a given event to occur when an inspection indicated in the request data is conducted at the location of the target, or when the inspection result data is sent to the diagnostic device 20.

Subsequently, in S107, the user obtains the delivery data with the user terminal 24. Among the plurality of users, a user who intends to conduct an inspection moves to the installation location of the target on foot, by train, car, or the like.

Subsequently, in S108, the user conducts an inspection to send inspection result data acquired as a result of the inspection from the user terminal 24 to the diagnostic device 20. For example, the user visually checks the appearance of the target to input, to the user terminal 24, the inspection result data acquired as a result of the check, and sends the same to the diagnostic device 20. Further, for example, the user captures an image of the appearance of the target with the user terminal 24 to send the captured appearance, as the inspection result data, from the user terminal 24 to the diagnostic device 20. Further, for example, the user records audio of the target with the user terminal 24 to send the recorded audio data, as the inspection result data, from the user terminal 24 to the diagnostic device 20. Further, for example, the user reads a meter value of the measuring instrument mounted to the target or provided in the vicinity of the target and so on, and inputs the meter value thus read to the user terminal 24 as the inspection result data to send the same to the diagnostic device 20.

Subsequently, in S109, the diagnostic device 20 receives, concerning the target diagnostic item, a plurality of pieces of inspection result data from the plurality of user terminals 24 of the plurality of users. Further, in S109, the diagnostic device 20 checks whether or not each set of the plurality of pieces of inspection result data is suitable as an inspection result of the target diagnostic item.

Subsequently, in S110, the diagnostic device 20 provides an incentive according to the importance degree assigned for the target diagnostic item to the user who has sent the suitable inspection result data. Specifically, the higher importance degree the target diagnostic item receives, the higher incentive the diagnostic device 20 provides.

The diagnostic device 20 may provide money to the user as the incentive. In such a case, the diagnostic device 20 performs processing for transferring money to a bank account registered in advance. The diagnostic device 20 may give award points, instead of money, to the user as the incentive. In such a case, the diagnostic device 20 sends award points to a user management number through an award points management company. This allows the user to receive a service according to the award points or to obtain a product according to the award points. Besides, the diagnostic device 20 may give a discount coupon or the like to the user as the incentive.

Subsequently, in S111, in a case where the diagnostic device 20 receives suitable inspection result data, the diagnostic device 20 adds the received inspection result data to the plurality of pieces of inspection result data on the target diagnostic item stored in the inspection result data storage 36. This allows the result receiver 52 to increase, concerning the target diagnostic item, the number of pieces of inspection result data stored in the inspection result data storage 36.

Subsequently, in S112, the diagnostic device 20 waits until a certain period of time has elapsed since the start of the delivery in S106. The diagnostic device 20 performs the processing of S110 and S111 every time the inspection result data is received from the user terminal 24 until a certain period of time has elapsed since the start of the delivery in S106. After the elapse of a certain period of time, the diagnostic device 20 proceeds to S113.

In S113, concerning the target diagnostic item, the diagnostic device 20 determines whether or not sufficient number of pieces of effective inspection result data for diagnosing is included in the plurality of pieces of inspection result data stored in the inspection result data storage 36. In S113, the diagnostic device 20 may perform the same processing as that of S101.

If the plurality of pieces of inspection result data do not include sufficient number of pieces of effective inspection result data for diagnosing (insufficient in S113), then the diagnostic device 20 returns to S102. The diagnostic device 20 repeats the determination from S101 to S112 until the plurality of pieces of inspection result data include sufficient number of pieces of effective inspection result data for diagnosing.

If the number of pieces of inspection result data increases and the plurality of pieces of inspection result data include sufficient number of pieces of effective inspection result data for diagnosing (sufficient in S113), then the diagnostic device 20 proceeds to S114.

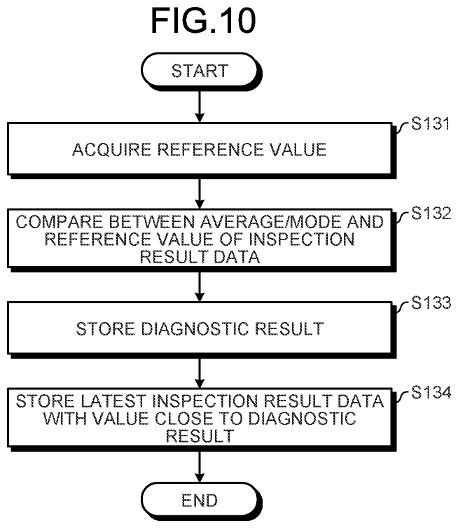

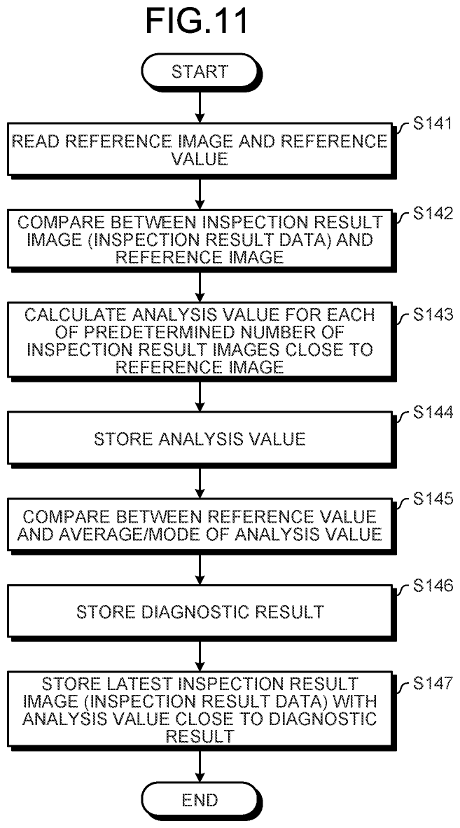

In S114, concerning the target diagnostic item, the diagnostic device 20 diagnoses the condition of the target on the basis of the plurality of pieces of inspection result data stored in the inspection result data storage 36. Note that an example of the diagnostic processing in S114 is further described with reference to FIG. 10 and FIG. 11.

When finishing the processing in S114, the diagnostic device 20 ends the flow of processing.

FIG. 9 is a flowchart depicting the flow of the sufficiency determination processing performed in S101 and S113 of FIG. 8. The diagnostic device 20 performs, in the sufficiency determination processing (S101 and S113 of FIG. 8), processing as depicted in FIG. 9, for example.

First, in S121, the diagnostic device 20 calculates the elapsed time since the latest diagnosing date and time. Subsequently, in S122, the diagnostic device 20 determines whether or not the elapsed time since the latest diagnosing date and time exceeds a given time. If the elapsed time does not exceed the given time (No in S122), then the diagnostic device 20 determines that the given time is not elapsed and ends the flow of processing. If the elapsed time exceeds the given time (Yes in S122), then the diagnostic device 20 proceeds to S123.

In S123, the diagnostic device 20 counts the number of pieces of inspection result data on the target diagnostic item stored in the inspection result data storage 36. Subsequently, in S124, the diagnostic device 20 determines whether or not the count number is equal to or greater than a preset threshold. If the number of pieces of inspection result data is not equal to or greater than the threshold (No in S124), then the diagnostic device 20 determines that number is insufficient and ends the flow of processing. If the number of pieces of inspection result data is equal to or greater than the threshold (Yes in S124), then the diagnostic device 20 proceeds to S125.

In S125, if the inspection result data is a numerical value (meter value or the like), then the diagnostic device 20 generates a histogram or a summary sheet of the plurality of pieces of inspection result data. In S125, if the inspection result data is image data, audio data, and so on, then the diagnostic device 20 performs given image analysis processing or speech analysis processing on the plurality of pieces of inspection result data to calculate an analysis value that indicates a result of the analysis of an image or audio. The diagnostic device 20 then generates a histogram or a summary sheet of the plurality of analysis values.

Subsequently, in S126, the diagnostic device 20 calculates an average and a variance of the plurality of pieces of inspection result data or the plurality of analysis values. Subsequently, in S127, the diagnostic device 20 analyzes a plurality of pieces of professional inspection result data, stored in the previous data storage 34, indicating results of previous inspections conducted by the professional on the target diagnostic items, and reads out a lower limit value and an upper limit value in the plurality of pieces of professional inspection result data.

Subsequently, in S128, the diagnostic device 20 determines whether or not at least a given rate of the plurality of pieces of inspection result data or the plurality of analysis values is included within a given range defined on the basis of the upper limit value and the lower limit value. For example, the diagnostic device 20 determines whether or not at least 90% of the plurality of pieces of inspection result data or the plurality of analysis values is included between the upper limit value and the lower limit value. Note that the given rate is arbitrarily set by the administrator. The range defined on the basis of the upper limit value and the lower limit value may be, for example, a range between a value lower than the upper limit value by a given margin amount and a value higher than the lower limit value by a given margin amount.

If at least a given rate of the plurality of pieces of inspection result data is included within the range defined on the basis of the upper limit value and the lower limit value (Yes in S128), then the diagnostic device 20 determines that it is sufficient and ends the flow of processing. Unless a given rate of the plurality of pieces of inspection result data is included within the range defined on the basis of the upper limit value and the lower limit value (No in S128), then the diagnostic device 20 determines that it is insufficient and ends the flow of processing.

The diagnostic device 20 performs the processing from S121 to S128, and thereby can determine whether or not the plurality of pieces of inspection result data include sufficient number of pieces of effective inspection result data for diagnosing. Specifically, the diagnostic device 20 can determine, concerning the diagnostic item, whether or not the plurality of pieces of inspection result data include sufficient number of pieces of effective inspection result data for diagnosing after a given time has elapsed since the latest diagnosing date and time. Further, the diagnostic device 20 can determine that the plurality of pieces of inspection result data include sufficient number of pieces of effective inspection result data for diagnosing if, concerning the diagnostic item, the number of pieces of inspection result data is equal to or greater than a preset threshold, and if at least a given rate of the plurality of pieces of inspection result data is included within a range defined on the basis of the lower limit value and the upper limit value of a plurality of pieces of professional inspection result data indicating results of previous inspections conducted by the professional.

The diagnostic device 20 may perform another processing as the determination processing for determining whether or not the plurality of pieces of inspection result data include sufficient number of pieces of effective inspection result data for diagnosing. For example, the upper limit value and the lower limit value may be values preset by the administrator.

For example, in a case where the inspection result data is information other than a numerical value, image data, audio data, or the like, the diagnostic device 20 may determine that the plurality of pieces of inspection result data include sufficient number of pieces of effective inspection result data for diagnosing, provided that the plurality of pieces of inspection result data include at least a given rate of information that matches or approximates information (text information, for example) indicated in the plurality of pieces of professional inspection result data indicating results of previous inspections conducted by the professional. For example, in a case where the inspection result data is information other than a numerical value, image data, audio data, or the like (text information, for example), the diagnostic device 20 may determine that the plurality of pieces of inspection result data include sufficient number of pieces of effective inspection result data for diagnosing, provided that the plurality of pieces of inspection result data include at least a given rate of information that matches or approximates information preset by the administrator.

FIG. 10 is a flowchart of the diagnostic processing, performed in S114 of FIG. 8, for a case where a numerical value is recorded as the inspection result data. In a case where a numerical value such as a meter value of a measuring instrument is recorded as the inspection result data, the diagnostic device 20 performs, for example, the processing as depicted in FIG. 10 in the diagnostic processing (S114 of FIG. 8).

First, in S131, the diagnostic device 20 acquires a preset reference value and the details of diagnosis. The reference value and the details of diagnosis are stored in correlation with the diagnostic item in the diagnostic item storage 32.

Subsequently, in S132, the diagnostic device 20 outputs diagnostic result data indicating a diagnostic result of the target on the basis of a comparison result of comparison between the reference value and an evaluation value that is an average or a mode of the plurality of pieces of inspection result data, and the contents (details) of diagnosis that are set in advance. For example, the details of diagnosis represent information such as: if the meter value is equal to or smaller than the reference value, then the target is in a satisfactory condition; and if the meter value is greater than the reference value, then the target is in a condition where maintenance is required. In such a case, the diagnostic device 20 outputs a diagnostic result that the target is in a satisfactory condition if the evaluation value is equal to or smaller than the reference value, and outputs a diagnostic result that the target is in a condition where maintenance is required if the evaluation value is greater than the reference value.

The diagnostic device 20 may store a plurality of reference values. In such a case, the diagnostic device 20 can output, for one diagnostic item, at least three types of diagnostic results according to the evaluation values of the plurality of pieces of inspection result data.

Subsequently, in S133, the diagnostic device 20 stores the diagnostic result data in the diagnostic result storage 54 together with the date and time of diagnosis. Subsequently, in S134, the diagnostic device 20 identifies the latest inspection result data with an error to the evaluation value equal to or less than given value among the plurality of pieces of inspection result data. The diagnostic device 20 then stores the latest inspection result data with an error to the evaluation value equal to or less than given value together with the diagnostic result in the diagnostic result storage 54. Thereby, the diagnostic device 20 can store the latest inspection result data close to the diagnostic result into the diagnostic result storage 54.

The diagnostic device 20 performs the processing of S131 to S134 described above to diagnose, in a case where a numerical value is recorded as the inspection result data, the condition of the target on the basis of the plurality of pieces of inspection result data acquired as a result of the inspection conducted by the plurality of users.

FIG. 11 is a flowchart of the diagnostic processing, performed in S114 of FIG. 8, for a case where image data is recorded as the inspection result data. In a case where image data is recorded as the inspection result data, the diagnostic device 20 performs, for example, such processing as that depicted in FIG. 11 in the diagnostic processing (S114 of FIG. 8). The diagnostic device 20 performs similar processing also when audio data is recorded as the inspection result data.

First, in S141, the diagnostic device 20 acquires (reads) a preset reference value, a reference image, and details of diagnosis. The reference value, the reference image, and the details of diagnosis are stored in correlation with the diagnostic item in the diagnostic item storage 32. The reference image may be, for example, an image that is obtained when the professional has previously captured an image of the target.

Subsequently, in S142, the diagnostic device 20 compares between each set of the plurality of pieces of diagnostic result data and the reference image to select a given number of diagnostic result data sets close to the reference image from among the plurality of pieces of diagnostic result data. For example, the diagnostic device 20 selects, from among the plurality of pieces of diagnostic result data, at least given number of diagnostic result data sets in which a perspective matches the reference image or is within a given error range. Note that the diagnostic device 20 does not necessarily perform the processing of S142.

Subsequently, in S143, the diagnostic device 20 performs preset image analysis processing on each set of the given number of diagnostic result data sets close to the reference image to calculate an analysis value. For example, the diagnostic device 20 performs pixel analysis processing on each set of the given number of diagnostic result data sets close to the reference image to calculate an analysis value of the size of a rusty area, the number of cracks, and so on.

Subsequently, in S144, the diagnostic device 20 stores an analysis value calculated for each set of the given number of diagnostic result data sets close to the reference image.

Subsequently, in S145, the diagnostic device 20 outputs diagnostic result data indicating a diagnostic result of the target on the basis of a comparison result of comparison between the reference value and an evaluation value that represents an average or a mode of a given number of analysis values, and the details of diagnosis that are set in advance. For example, the details of diagnosis represent information such as: if the evaluation value (for example, an average or a mode of the rusty area or the number of cracks) is equal to or smaller than the reference value, then the target is in a satisfactory condition; and if the evaluation value is greater than the reference value, then the target is in a condition where maintenance is required. In such a case, the diagnostic device 20 outputs a diagnostic result that the target is in a satisfactory condition if the evaluation value is equal to or smaller than the reference value, and outputs a diagnostic result that the target is in a condition where maintenance is required if the evaluation value is greater than the reference value.

Subsequently, in S146, the diagnostic device 20 stores the diagnostic result data in the diagnostic result storage 54 together with the date and time of diagnosis. Subsequently, in S147, the diagnostic device 20 identifies the latest inspection result data with an error to the evaluation value equal to or less than the given value among the given number of pieces of inspection result data. The diagnostic device 20 then stores the latest inspection result data with an error to the evaluation value equal to or less than given value together with the diagnostic result in the diagnostic result storage 54. Thereby, the diagnostic device 20 can store the latest inspection result data close to the diagnostic result into the diagnostic result storage 54.

The diagnostic device 20 performs the processing of S141 to S147 described above to diagnose, in a case where image data is recorded as the inspection result data, the condition of the target on the basis of the plurality of pieces of inspection result data acquired as a result of the inspection conducted by the plurality of users.

FIG. 12 is a diagram for explaining an example of processing for assigning an importance degree. Greek numbers of FIG. 12 represent the magnitude of an influence.

For example, the diagnostic device 20 may determine a level of an importance degree by combination of the elapsed time since the latest diagnosing date and time for the target diagnostic item and an influence that is set in advance for the diagnostic item. The influence is set, for example, in accordance with a degree of influence of the diagnostic item on the safety of the target, or a degree of influence of the diagnostic item on the quality of the target. For example, as illustrated in FIG. 12, the diagnostic device 20 stores, for each diagnostic item, a table in which a level of an importance degree is set in accordance with the length of the elapsed time, and refers to the table stored to determine a level of an importance degree.

Further, the latest diagnosing date and time may be a date and time at which the professional conducts an inspection. Thereby, in a case where a certain period of time is exceeded, the diagnostic device 20 can make the professional conduct an inspection and diagnose for a more accurate diagnosis.

The diagnostic system 10 according to the first embodiment described above makes a plurality of users, who are not professionals, inspect the target, and diagnoses the condition of the target on the basis of a plurality of pieces of inspection result data acquired as a result of the inspections by the plurality of users. This allows the diagnostic system 10 to reduce the workload on a professional and reduce the diagnostic cost.

Further, as more speedy or accurate diagnosing for the target diagnostic item is required, the diagnostic system 10 assigns the heightened importance degree.

The diagnostic system 10 then provides an incentive according to the importance degree to a user who has conducted the inspection. This allows the diagnostic system 10 to prompt the user to conduct an inspection for an inspection item assigned as a high importance degree, leading to speedy diagnosing for an inspection item assigned as a high importance degree.

Further, the diagnostic system 10 instructs the professional to conduct an inspection for an inspection item of which importance degree is higher than the threshold. Thereby, the diagnostic system 10 can make the professional inspect and diagnose an inspection item for which more accurate diagnosing is required. Thus, in the diagnostic system 10, it is possible to reduce the workload on the professional by reducing the number of times of the inspection and diagnosis by the professional while reliability of diagnosis is ensured.

### Second Embodiment

The description goes on to the diagnostic system 10 according to the second embodiment. In the description of the second and subsequent embodiments, constituent elements that have substantially the same configuration and function as the constituent elements described in the previous embodiment are assigned with the same sign and the detailed description thereof are omitted except for differences therebetween.

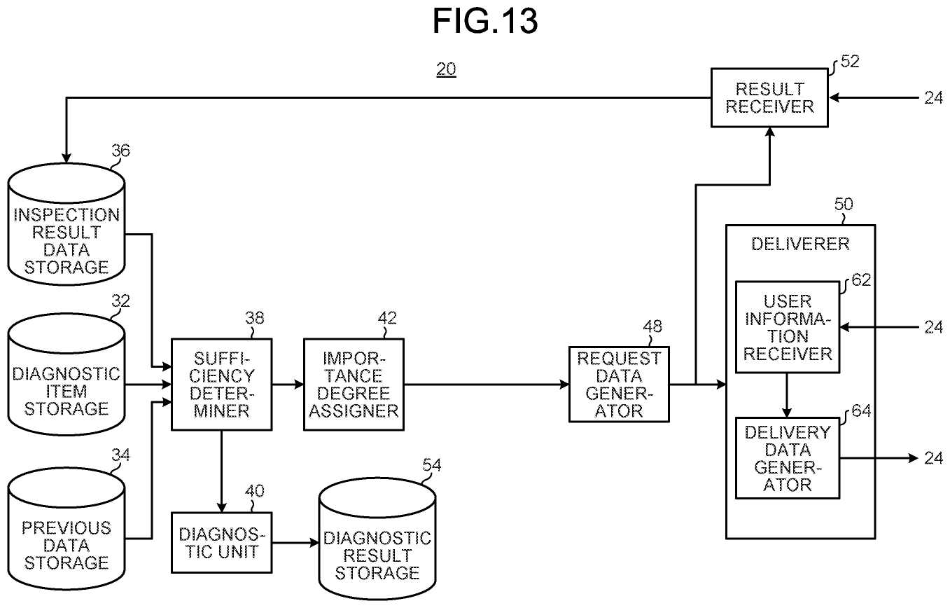

FIG. 13 is a diagram illustrating the functional configuration of the diagnostic device 20 according to the second embodiment. In comparison with the configuration of the diagnostic device 20 according to the first embodiment illustrated in FIG. 2, the diagnostic device 20 according to the second embodiment is not equipped with the person determiner 44 and the inspection instructing unit 46. In other words, the diagnostic device 20 according to the second embodiment does not instruct the professional to conduct an inspection and diagnose, but requests users to conduct an inspection for all diagnostic items. Further, in the flowchart of FIG. 8, the diagnostic device 20 does not perform the processing of S103 and S104, and performs the processing of S102 and then performs the processing of S105.

In the second embodiment, in a case where the sufficiency determiner 38 performs the sufficiency determination processing on the same diagnostic item a plurality of times, the importance degree assigner 42 may raise the importance degree for each determination processing. Thereby, in a case where the number of pieces of effective inspection result data necessary for the diagnosis is not collected, the diagnostic system 10 according to the second embodiment can raise the importance degree to increase an incentive provided to the user, and urge a user to conduct an inspection more strongly.

### Third Embodiment

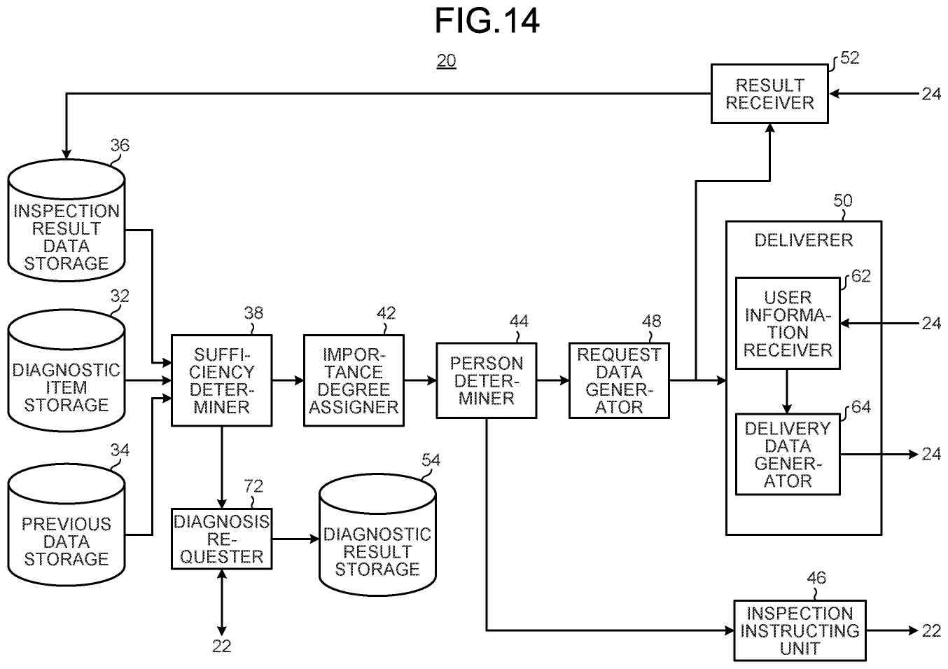

The description goes on to the diagnostic system 10 according to the third embodiment. FIG. 14 is a diagram illustrating the functional configuration of the diagnostic device 20 according to the third embodiment. In comparison with the configuration of the diagnostic device 20 according to the first embodiment illustrated in FIG. 2, the diagnostic device 20 according to the third embodiment includes a diagnosis requester 72 instead of the diagnostic unit 40.

In a case where, concerning a target diagnostic item, a plurality of pieces of inspection result data stored in the inspection result data storage 36 include sufficient number of pieces of effective inspection result data for diagnosing, the diagnosis requester 72 sends, to the professional terminal 22, diagnosis request data for requesting a professional to diagnose. Further, instead of the transmission of the diagnosis request data to the professional terminal 22, the diagnosis requester 72 may send the diagnosis request data to a server of a diagnostic company or the like for performing the diagnostic processing. In such a case, the diagnostic company requests the professional to diagnose.

The diagnosis request data includes a plurality of pieces of inspection result data on the target diagnostic item. The diagnosis request data may further include the details of diagnosis for the target diagnostic item. The professional receives the diagnosis request data and conducts an inspection with reference to the plurality of pieces of inspection result data and the details of diagnosis included in the diagnosis request data. The professional then sends, concerning the target diagnostic item, diagnostic result data including a diagnostic result to the diagnostic device 20.

The diagnosis requester 72 receives the diagnostic result data sent from the professional terminal 22 held by the professional, and stores the received diagnostic result data together with the date and time of diagnosis into the diagnostic result storage 54. Further, the diagnosis requester 72 may receive, from the professional terminal 22 held by the professional, the latest inspection result data close to the diagnostic result.

Further, the diagnosis requester 72 may perform the same processing as the diagnostic processing by the diagnostic unit 40 of the first embodiment. In such a case, the diagnosis requester 72 may add, to the diagnosis request data, the diagnostic result data and the latest inspection result data close to the diagnostic result as the reference information and send the resultant to the professional.

Further, the professional may determine that collecting inspection result data is necessary because the plurality of pieces of inspection result data stored in the inspection result data storage 36 do not include the sufficient number of pieces of inspection result data effective for diagnosing. In such a case, the diagnosis requester 72 receives a determination result indicating that collecting inspection result data is necessary from the professional terminal 22 held by the professional. In a case where such a determination result is received, the diagnosis requester 72 may raise a threshold, set in the sufficiency determiner 38, for determining whether or not to include effective inspection result data, and cause the sufficiency determiner 38 to perform the determination processing again. Further, in a case where such a determination result is received, the diagnosis requester 72 may raise the importance degree of the corresponding diagnostic item and urge the user to conduct an inspection more strongly.

In the diagnostic system 10 according to the third embodiment, it is possible to reduce the cost for inspection by a professional by making the user conduct an inspection and to diagnose the condition of the target more accurately.

### Fourth Embodiment

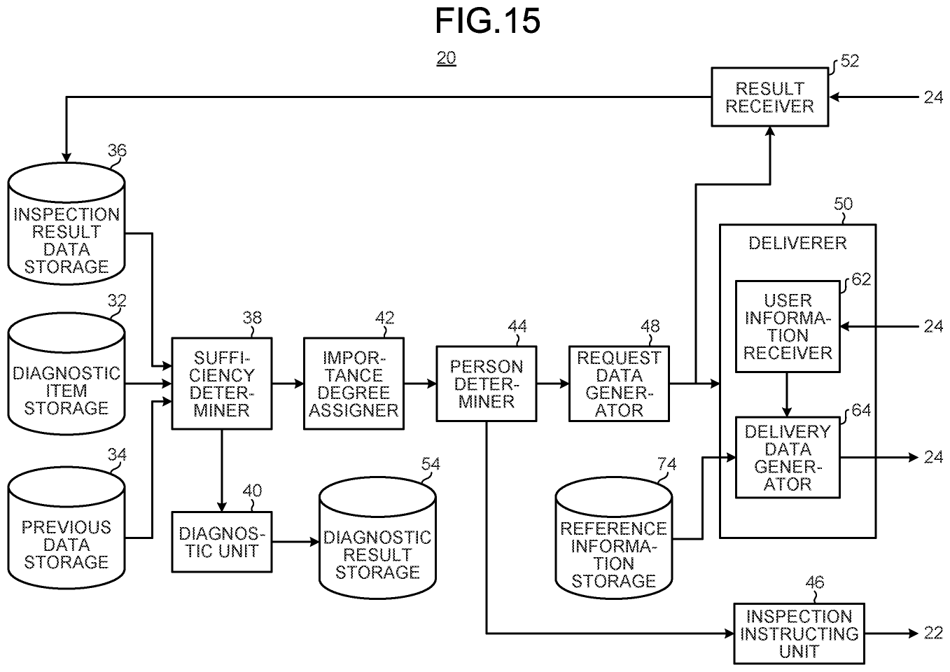

The description goes on to the diagnostic system 10 according to the fourth embodiment. FIG. 15 is a diagram illustrating the functional configuration of the diagnostic device 20 according to the fourth embodiment. In comparison with the configuration of the diagnostic device 20 according to the first embodiment illustrated in FIG. 2, the diagnostic device 20 according to the fourth embodiment further includes reference information storage 74. Note that the diagnostic device 20 of the second embodiment illustrated in FIG. 13 or the third embodiment illustrated in FIG. 14 may be configured to further include the reference information storage 74.

The reference information storage 74 stores, concerning each of the plurality of diagnostic items, reference information referred to when a user, who inspects the condition of the target, conducts an inspection. The deliverer 50 reads out the reference information concerning the corresponding diagnostic item from the reference information storage 74 to add the reference information to the delivery data.

The reference information may include, for example, the previous inspection result data. Further, the reference information may be a layout diagram illustrating the location of the target, the location of the measuring instrument, and so on in a facility where the target is installed. Further, the reference information may include a reference image serving as a sample of composition in image-capturing of the target, a recording position in recording audio of the target, a direction and recommended settings, a recommended position of the user in a case where the user visually checks the target. This enables the user to inspect the target more accurately.

In the diagnostic system 10 according to the fourth embodiment, it is possible to make the user conduct an inspection more accurately and to reduce the cost for inspection by a professional.

Hardware Configuration

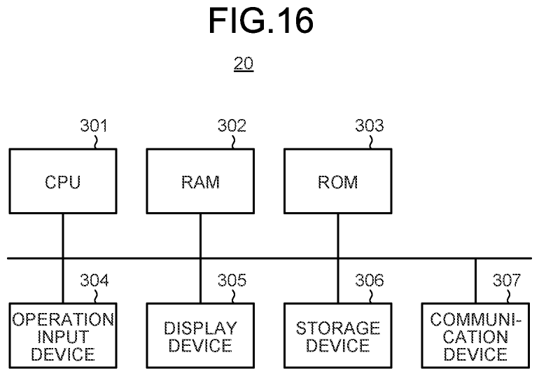

FIG. 16 is a diagram illustrating an example of the hardware configuration of the diagnostic device 20 according to the embodiments. The diagnostic device 20 is implemented, for example, by a computer having the hardware configuration illustrated in FIG. 16. The diagnostic device 20 includes a central processing unit (CPU) 301, a random access memory (RAM) 302, a read only memory (ROM) 303, an operation input device 304, a display device 305, a storage device 306, and a communication device 307. The units are connected to one another by a bus.

The CPU 301 is a processor that executes arithmetic processing, control processing, and so on in accordance with a program. The CPU 301 uses a given area of the RAM 302 as a work area to execute various processing in cooperation with a program stored in the ROM 303, the storage device 306, and so on.

The RAM 302 is a memory such as synchronous dynamic random access memory (SDRAM). The RAM 302 functions as a work area for the CPU 301. The ROM 303 is a non-rewritable memory that stores the program and various information.

The operation input device 304 is an input device such as a mouse or a keyboard. The operation input device 304 receives information inputted by user operation as an instruction signal to output the instruction signal to the CPU 301.

The display device 305 is a display device such as a liquid crystal display (LCD). The display device 305 displays various information on the basis of a display signal from the CPU 301.

The storage device 306 is a device that writes and reads data to and from a semiconductor storage medium such as a flash memory, a storage medium that can record magnetically or optically, and so on. The storage device 306 writes and reads data to and from a storage medium in accordance with control from the CPU 301. The communication device 307 performs communication with an external device via the network in accordance with control from the CPU 301.

The program executed in the computer has a module configuration including a sufficiency determination module, a diagnostic module (or a diagnosis request module), an importance-degree assigning module, a person determination module, an inspection instructing module, a request data generation module, a delivery module, and a result receiving module. The program is deployed and executed on the RAM 302 by the CPU 301 (processor) to cause the computer to function as the sufficiency determiner 38, the diagnostic unit 40 (or the diagnosis requester 72), the importance degree assigner 42, the person determiner 44, the inspection instructing unit 46, the request data generator 48, the deliverer 50, and the result receiver 52. Note that a part or the whole of the diagnostic unit 40 (or the diagnosis requester 72), the importance degree assigner 42, the person determiner 44, the inspection instructing unit 46, the request data generator 48, the deliverer 50, and the result receiver 52 may be implemented in hardware circuitry. Further, the RAM 302 and the storage device 306 function as the diagnostic item storage 32, the previous data storage 34, the inspection result data storage 36, the diagnostic result storage 54, and the reference information storage 74.

A program to be executed by the computer is provided in a file of a format that can be installed or executed by the computer and recorded on a computer-readable recording medium such as a CD-ROM, a flexible disk, a CD-R, or a digital versatile disk (DVD).

The program may be stored on a computer connected to a network such as the Internet, and provided after being downloaded via the network. The program may be provided or distributed via the network such as the Internet. A program executed in the diagnostic device 20 may be installed on the ROM 303 or the like in advance and provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device diagnosing a condition of a target, the device comprising:
one or more hardware processors configured to function as:
a sufficiency determiner configured to determine, concerning a diagnostic item to be diagnosed for the target, whether or not a plurality of pieces of inspection result data include sufficient number of pieces of inspection result data for diagnosing, each of the plurality of pieces of inspection result data indicating a result of an inspection conducted by a user who inspects the condition of the target; and
a diagnostic unit configured to diagnose, concerning the diagnostic item, the condition of the target on a basis of the plurality of pieces of inspection result data in a case where the plurality of pieces of inspection result data include sufficient number of pieces of inspection result data for diagnosing.

2. The information processing device according to claim 1, wherein the one or more hardware processors are configured to further function as:
a request data generator configured to generate, concerning the diagnostic item, request data for requesting the user to conduct an inspection in a case where the plurality of pieces of inspection result data do not include the sufficient number of pieces of inspection result data for diagnosing.

3. The information processing device according to claim 2, wherein the one or more hardware processors are configured to further function as:
a deliverer configured to deliver the request data to a plurality of user terminals held by users.

4. The information processing device according to claim 3, wherein
the users are different from a professional who inspects the condition of the target.

5. The information processing device according to claim 4, wherein
the sufficiency determiner determines, concerning the diagnostic item, whether or not the plurality of pieces of inspection result data indicating results of inspections conducted by the users include the sufficient number of pieces of effective inspection result data for diagnosing,
in a case where, concerning the diagnostic item, the plurality of pieces of inspection result data include the sufficient number of effective inspection result data for diagnosing, the diagnostic unit diagnoses the condition of the target on the basis of the plurality of pieces of inspection result data, and
in a case where, concerning the diagnostic item, the plurality of pieces of inspection result data do not include the sufficient number of pieces of effective inspection result data for diagnosing, the request data generator generates the request data.

6. The information processing device according to claim 5, wherein
the one or more hardware processors are configured to further function as:
a result receiver configured to receive, concerning the diagnostic item, inspection result data from the plurality of user terminals to add the inspection result data received to the plurality of pieces of inspection result data, and
the sufficiency determiner repeats determination processing until the plurality of pieces of inspection result data include the sufficient number of pieces of effective inspection result data for diagnosing.

7. The information processing device according to claim 6, wherein
the sufficiency determiner determines, concerning the diagnostic item, whether or not the sufficient number of pieces of effective inspection result data for diagnosing is included after a given time elapses since a last diagnosing date and time.

8. The information processing device according to claim 6, wherein
the sufficiency determiner determines, concerning the diagnostic item, that the sufficient number of pieces of effective inspection result data for diagnosing is included in a case where the number of pieces of inspection result data is equal to or greater than a preset threshold, and in a case where at least a given rate of the plurality of pieces of inspection result data is included within a rage defined on a basis of a lower limit value and an upper limit value of a plurality of pieces of result data indicating results of inspections previously conducted by the professional.

9. The information processing device according to claim 6, wherein the one or more hardware processors are configured to further function as:
an importance degree assigner configured to assign an importance degree of diagnosing to the diagnostic item in a case where the plurality of pieces of inspection result data do not include the sufficient number of pieces of effective inspection result data for diagnosing.

10. The information processing device according to claim 9, wherein
the importance degree assigner heightens importance degree as a rate of the number of pieces of effective inspection result data included in the plurality of pieces of inspection result data relative to a preset number for the diagnostic item lowers.

11. The information processing device according to claim 9, wherein
the result receiver provides, concerning the diagnostic item, an incentive according to the importance degree assigned for the diagnostic item to the users who have sent the inspection result data.

12. The information processing device according to claim 5, wherein
the one or more hardware processors are configured to further function as:
an importance degree assigner configured to assign an importance degree of diagnosing to the diagnostic item; and
an inspection instructing unit configured to instruct the professional to conduct an inspection for the diagnostic item in a case where the plurality of pieces of inspection result data do not include the sufficient number of pieces of effective inspection result data for diagnosing, and in a case where the importance degree is higher than a preset value, and
the request data generator generates the request data for requesting the users to conduct an inspection for the diagnostic item in a case where the plurality of pieces of inspection result data do not include the sufficient number of pieces of effective inspection result data for diagnosing, and in a case where the importance degree is equal to or lower than the preset value.

13. An information processing device for requesting to conduct an inspection for diagnosing of a condition of a target, the device comprising:
an importance degree assigner configured to assign an importance degree of diagnosing concerning a diagnostic item to be diagnosed for the target;
a request data generator configured to generate request data for requesting users who are to inspect the condition of the target to conduct an inspection for the diagnostic item in a case where the importance degree assigned to the diagnostic item is equal to or lower than the preset value; and
a deliverer configured to deliver the request data to a plurality of user terminals held by the users.

14. The information processing device according to claim 13, wherein
the users are different from a professional who inspects the condition of the target.

15. The information processing device according to claim 14, wherein
the one or more hardware processors are configured to further function as:
an inspection instructing unit configured to instruct the professional to conduct an inspection for the diagnostic item in a case where the importance degree assigned to the diagnostic item is higher than a preset value.

16. The information processing device according to claim 13, wherein
the importance degree assigner heightens the importance degree as the elapsed time since a last diagnosing date and time for the diagnostic item increases.

17. The information processing device according to claim 13, wherein
the importance degree assigner heightens the importance degree when a degree of influence is preset in the diagnostic item and as the degree of influence set for the diagnostic item increases.

18. The information processing device according to claim 13, wherein the one or more hardware processors are configured to further function as:
a result receiver configured to receive, concerning the diagnostic item, inspection result data from the plurality of user terminals and provide an incentive according to the importance degree assigned for a corresponding diagnostic item to the users who have sent the inspection result data.

19. An information processing method adapted to diagnose a condition of a target with an information processing device, the method comprising:
determining, by the information processing device, concerning a diagnostic item to be diagnosed for the target, whether or not a plurality of pieces of inspection result data include sufficient number of pieces of inspection result data for diagnosing, each of the plurality of pieces of inspection result data indicating a result of an inspection conducted by a user who inspects the condition of the target; and
diagnosing, by the information processing device, concerning the diagnostic item, the condition of the target on a basis of the plurality of pieces of inspection result data in a case where the plurality of pieces of inspection result data include the sufficient number of pieces of inspection result data for diagnosing.

20. An information processing method adapted to request to conduct an inspection for diagnosing a condition of a target with an information processing device, the method comprising:
assigning, by the information processing device, an importance degree of diagnosing concerning a diagnostic item to be diagnosed for the target;
generating, by the information processing device, request data for requesting users who are to inspect the condition of the target to conduct an inspection for the diagnostic item in a case where the importance degree assigned to the diagnostic item is equal to or lower than the preset value; and
delivering, by the information processing device, the request data to a plurality of user terminals held by the users.

21. A computer program product having a computer readable medium including programmed instructions, wherein the instructions, when executed by a computer, cause the computer to function as an information processing device diagnosing a condition of a target,
the instructions causing the computer to function as:
a sufficiency determiner configured to determine, concerning a diagnostic item to be diagnosed for the target, whether or not a plurality of pieces of inspection result data include sufficient number of pieces of inspection result data for diagnosing, each of the plurality of pieces of inspection result data indicating a result of an inspection conducted by a user who inspects the condition of the target; and
a diagnostic unit configured to diagnose, concerning the diagnostic item, the condition of the target on a basis of the plurality of pieces of inspection result data in a case where the plurality of pieces of inspection result data include the sufficient number of pieces of inspection result data for diagnosing.

22. A computer program product having a computer readable medium including programmed instructions, wherein the instructions, when executed by a computer, cause the computer to function as an information processing device requesting to conduct an inspection for diagnosing of a condition of a target,
the instructions causing the computer to function as:
an importance degree assigner configured to assign an importance degree of diagnosing concerning a diagnostic item to be diagnosed for the target;
a request data generator configured to generate request data for requesting users who are to inspect the condition of the target to conduct an inspection for the diagnostic item in a case where the importance degree assigned to the diagnostic item is equal to or lower than the preset value; and
a deliverer configured to deliver the request data to a plurality of user terminals held by the users.

23. An information processing system comprising:
an information processing device diagnosing a condition of a target; and
a plurality of user terminals held by users who are to inspect the condition of the target, wherein
the information processing device comprises:
a sufficiency determiner configured to determine, concerning a diagnostic item to be diagnosed for the target, whether or not a plurality of pieces of inspection result data include sufficient number of pieces of inspection result data for diagnosing, each of the plurality of pieces of inspection result data indicating a result of an inspection conducted by each user, and
a diagnostic unit configured to diagnose, concerning the diagnostic item, the condition of the target on a basis of the plurality of pieces of inspection result data in a case where the plurality of pieces of inspection result data include the sufficient number of pieces of inspection result data for diagnosing.

24. An information processing system comprising:
an information processing device requesting to conduct an inspection for diagnosing of a condition of a target; and
a plurality of user terminals held by users who are to inspect the condition of the target, wherein
the information processing device comprises:
an importance degree assigner configured to assign an importance degree of diagnosing concerning a diagnostic item to be diagnosed for the target,
a request data generator configured to generate request data for requesting the users to conduct an inspection for the diagnostic item in a case where the importance degree assigned to the diagnostic item is equal to or lower than the preset value, and
a deliverer configured to deliver the request data to the plurality of user terminals held by the users.
